(19) United States
(12) Patent Application Publication
(10) Pub. No.: US 2012/0313825 A1
(43) Pub. Date: Dec. 13, 2012

(54) ANTENNA ASSEMBLY AND PORTABLE WIRELESS TERMINAL

(76) Inventors: Mikio Kuramoto, Osaka-shi (JP); Hiroyuki Takebe, Osaka-shi (JP); Hiroyasu Suetake, Osaka-shi (JP); Toshinori Kondo, Osaka-shi (JP); Nozomu Hikino, Osaka-shi (JP)

(21) Appl. No.: 13/580,937

(22) PCT Filed: Feb. 22, 2011
(86) PCT No.: PCT/JP2011/053866

§ 371 Date: Aug. 23, 2012

(30) Foreign Application Priority Data
Feb. 24, 2010 (JP) 2010-039289

(51) Int. Cl. H01Q 1/38

(52) U.S. Cl. 343/700 MS

(57) ABSTRACT

An antenna assembly (110) includes an antenna base (115) and antenna elements (111 to 113) formed on a surface of the antenna base (115). The antenna base (115) has: a connection surface (115b) on which connecting ends (111b to 113b) of the antenna elements (111 to 113) are formed, the connecting ends (111b to 113b) being connected to the wireless section circuit; and a through hole (106) formed through the antenna base (115) from the connection surface (115b) to another surface (115a). At least one of the antenna elements, for example, an antenna element (112) is configured so as to pass through the through hole (106).

### TECHNICAL FIELD

The present invention relates to an antenna assembly including a plurality of antenna elements, and a portable wireless terminal including the antenna assembly.

### BACKGROUND ART

Some of wireless devices are provided with a built-in antenna including a plurality of antenna elements. For example, in wireless devices, such as a portable wireless terminal of clam shell type in which two housings are connected at a hinge openably and closably to each other, an antenna is often provided at the hinge in one of the housings. In wireless devices of straight type in which only one housing is provided, an antenna is most often provided in any one of longitudinal ends of the housing. In wireless devices of a type in which two housings are provided and one of the housing slides with respect to the other housing, an antenna is often provided in any one of longitudinal ends of any one of the housings. In such cases, arrangement of antenna elements within the antenna plays an important role in antenna characteristics. Particularly, in a complicated antenna including a plurality of antenna elements, it is significantly useful to arrange the antenna elements more appropriately.

Recently, an antenna for use in a portable wireless terminal is often integrated into its housing. Such an antenna has various types of configurations. Examples of such various types of antenna configuration include: (i) an antenna obtained by applying an FPC on which antenna elements are formed to an inside of a housing or to a fixing resin, (ii) an antenna obtained by fixing (e.g., fixing, supporting, or fitting) antenna elements made from a sheet metal to an antenna base made from a resin or other material, and (iii) an antenna obtained by plating with metal a surface of an antenna base made from a resin or other material, in which the plated part serves as an antenna element.

In a case where there is an antenna base, in addition to an antenna element, as with the cases described above, the antenna element and the antenna base can be collectively referred to as an antenna assembly.

With respect to the above item (iii) “an antenna obtained by plating with metal a surface of an antenna base made from a resin or other material, in which the plated part serves as an antenna element”, the following description will discuss, with reference to FIGS. 14 and 15, a conventional arrangement of antenna elements as described in Non-patent Literature 1. (a) of FIG. 14 is a top perspective view illustrating a conventional portable wireless terminal 900, in particularly, an inside of a housing 901 in which antennas are arranged. (b) of FIG. 14 is a side perspective view illustrating the portable wireless terminal 900. (c) of FIG. 14 illustrates the portable wireless terminal 900 of (a) of FIG. 14 in a state in which an antenna base 915 is omitted. FIG. 15 illustrates from different directions an antenna assembly 920 to be provided in the portable wireless terminal 900.

As illustrated in (b) of FIG. 14, the portable wireless terminal 900 is of clam shell type, and includes a first housing 901 and a second housing 902, the first housing 901 and the second housing 902 being connected openably and closably via a coupling member 903.

The portable wireless terminal 900 includes, for cellular communication, a first antenna element 911 which operates in 800 to 900 MHz band; a third antenna element 913 which operates in 1.7 to 2.1 GHz band; and a wireless section circuit for cellular communication 921. The portable wireless terminal 900 further includes, for utilization of GPS, a second antenna element 912 which operates in 1.5 GHz band; and a wireless section circuit for GPS 923. The wireless section circuit for cellular communication 921 and the wireless section circuit for GPS 923 are provided on a circuit board 920 which is integrated into the first housing 901. Further, a camera 922 is provided on the circuit board 920.

As illustrated in FIG. 14, the first antenna element 911 and the third antenna element 913 are (i) formed by metal plating applied to a surface of the antenna base 915 disposed on the circuit board 920, and (ii) arranged at outermost part of the housing 901. On the other hand, the second antenna element 912 is formed on the circuit board 920. Therefore, the second antenna element 912, which is located close to a ground or other metal body on the circuit board 920, has deteriorated characteristics. However, the second antenna element 912 hardly affects characteristics of the first antenna element 911 and the third antenna element 913. As such, the antenna including such an arrangement of antenna elements is designed to attain an antenna for cellular communication having good characteristics at some sacrifice of characteristics of an antenna for GPS.

Further, the first housing 901 includes, on its four corners, bosses 909a to 909d which receive screws for fixing the first housing 901. Therefore, the antenna base 915 arranged on one of longitudinal ends of the first housing 901 has a boss hole 906 through which the boss 909a passes. Large parts of the first antenna element 911 and the third antenna base 915, and extend to a connection surface 915b of the antenna base 915 along a side surface of the antenna base 915 so as to be connected to the circuit board 920. The following description will discuss such a configuration in further detail with reference to FIG. 15. As illustrated in (a) of FIG. 15, large parts of the antenna elements 911 and 913 are formed on the top surface 915a. And, as illustrated in (b) and (c) of FIG. 15, the antenna elements 911 and 913 extend from the top surface 915a to the connection surface 915b along the side surface of the antenna base 915. As such, in the conventional configuration in which (i) metal plating is applied to a surface of the antenna base made from resin or other material and (ii) the metal plating serves as an antenna element, the antenna element is routed from the top surface 915a to the connection surface 915b along the side surface of the antenna base 915.

For connection of the antenna element to the circuit board, a spring mounted on the circuit board is commonly used. The connection part of the antenna element to the circuit board is commonly arranged in the vicinity of a corner of the circuit board, in order to improve antenna characteristics.

### CITATION LIST

### Non-Patent Literature

Non-Patent Literature 1
https://fjallfoss.fcc.gov/oetcf/eas/reports/ViewExhibitReport.cfm?mode=Exhibits&RequestTimeout=500&calledFromFrame=N&application_id=69075786fcc_id=‘APYHR000071’ (an antenna shape of APYHR000071 registered in the Federal Communications Commission (FCC))

### SUMMARY OF INVENTION

### Technical Problem

As such, according to a type of an antenna assembly as described in Non-patent Literature 1, in which metal plating is applied to a surface of an antenna base, an antenna element formed on a top surface of the antenna base is routed to a connection surface along a side surface of the antenna base. Therefore, particularly in a case where a plurality of antenna elements are formed on the antenna base and power feed sections of the plurality of antenna elements are arranged close to each other, routing of the antenna elements are greatly limited.

The present invention has been accomplished in view of the problem, and an essential object of the present invention is to provide an antenna assembly including a plurality of antenna elements which are formed by means of metal plating or the like applied to a surface of an antenna base, in which the antenna elements are efficiently routed.

### Solution to Problem

An antenna assembly in accordance with the present invention is an antenna assembly including: an antenna base; and a plurality of antenna elements formed on a surface of the antenna base, the antenna base having: a connection surface on which connecting ends of the plurality of antenna elements are provided, the connecting ends being ends which are connected to a wireless section circuit; and a through hole formed through the antenna base from the connection surface to another surface; and at least one of the antenna elements being configured to pass through the through hole.

According to the configuration, at least one of the antenna elements passes through the through hole so as to be routed to the connection surface. It is therefore possible to achieve an improvement in a degree of freedom when routing the antenna elements, as compared with a case where all of the antenna elements are routed to the connection surface along the side surface. For example, since the antenna elements can be distanced from each other, it is possible to alleviate mutual interference between the antennas. It is further possible to avoid deterioration in antenna characteristics which deterioration may be caused metal bodies mounted on the circuit board or arranged in the housing, in order to prevent from crossing the other antenna element. Furthermore, the through hole can be provided in an arbitrary place. This allows a degree of freedom in an arrangement of antenna elements to be significantly improved. An ideal arrangement of the antenna elements can thus be achieved. Moreover, the antenna element can pass through anywhere inside of the through hole. This also allows a connection part of the antenna element on the circuit board to be arranged in an arbitrary place near the through hole.

### Advantageous Effects of Invention

According to an antenna assembly of the present invention, at least one of antenna elements passes through a through hole. It is therefore possible to provide an antenna assembly including a plurality of antenna elements, in which the antenna elements are efficiently routed.

### BRIEF DESCRIPTION OF DRAWINGS

FIG. 1 is a diagram schematically illustrating a configuration of an antenna assembly in accordance with an embodiment (Embodiment 1) of the present invention. (a) of FIG. 1 is a top view, (b) of FIG. 1 is a rear view, and (c) of FIG. 1 is an oblique perspective view of the antenna assembly.

FIG. 2 is a top perspective view illustrating a portable wireless terminal in accordance with the embodiment (Embodiment 1) of the present invention in a state in which the antenna assembly is omitted.

FIG. 3 is a top perspective view illustrating the portable wireless terminal in accordance with the embodiment (Embodiment 1) of the present invention in a state in which an antenna assembly is provided.

FIG. 4 illustrates various configurations of an antenna element. (a) of FIG. 4 illustrates a configuration in which no boss hole is provided, (b) of FIG. 4 illustrates a configuration in which a boss hole is provided through which an antenna element does not pass, and (c) of FIG. 4 illustrates a configuration in which a boss hole is provided through which an element passes.

FIG. 5 is a diagram schematically illustrating a configuration of an antenna assembly in accordance with an embodiment (Embodiment 2) of the present invention. (a) of FIG. 5 is a top view and (b) of FIG. 5 is a rear view of the antenna assembly.

FIG. 6 is a diagram schematically illustrating a configuration of an antenna assembly in accordance with an embodiment (Embodiment 3) of the present invention. (a) of FIG. 6 is a top view and (b) of FIG. 6 is a rear view of the antenna assembly.

FIG. 7 is a top perspective view schematically illustrating a portable wireless terminal in accordance with an embodiment (Embodiment 3) of the present invention.

FIG. 8 is a diagram schematically illustrating a configuration of antenna assembly in accordance with an embodiment (Embodiment 4) of the present invention. (a) of FIG. 8 is a top view and (b) of FIG. 8 is a rear view of the antenna assembly.

FIG. 9 is a diagram schematically illustrating a configuration of an antenna in accordance with an embodiment (Embodiment 4) of the present invention.

(a) of FIG. 10 is a diagram schematically illustrating a configuration of an antenna in accordance with an embodiment (Embodiment 5) of the present invention, and (b) and (c) of FIG. 10 illustrate wires on a circuit board.

FIG. 11 is a diagram schematically illustrating a configuration of a wireless section circuit in accordance with an embodiment (Embodiment 4) of the present invention.

FIG. 12 is a graph showing frequency characteristics of a parallel resonant circuit.

FIG. 13 is a Smith chart showing frequency characteristics of a first antenna element and a third antenna element in accordance with an embodiment (Embodiment 4) of the present invention.

FIG. 14 illustrates schematically a configuration of a portable wireless terminal in accordance with a conventional technique. (a) of FIG. 14 is a top perspective view, (b) of FIG. 14 is a side perspective view, and (c) of FIG. 14 illustrates a state in which an antenna base is omitted from the diagram of (a).

FIG. 15 is a diagram illustrating from various directions an antenna assembly 920 included in the portable wireless terminal in accordance with a conventional technique.

### DESCRIPTION OF EMBODIMENTS

The following description will discuss embodiments of the present invention with reference to drawings. Note that the following description will be made on the assumption that an antenna in accordance with the present invention is included in a portable wireless terminal which carries out a wireless communication for telephone calls with a base station. Note, however, that the antenna in accordance with the present invention is not limited to the antenna included in a portable wireless terminal which carries out a wireless communication for telephone calls with a base station, and can therefore be applied to a general antenna which receives and/or sends a carrier wave in which some signals are superimposed. Therefore, the antenna in accordance with the present invention can be an antenna included in a wireless device other than the portable wireless terminal.

### Embodiment 1

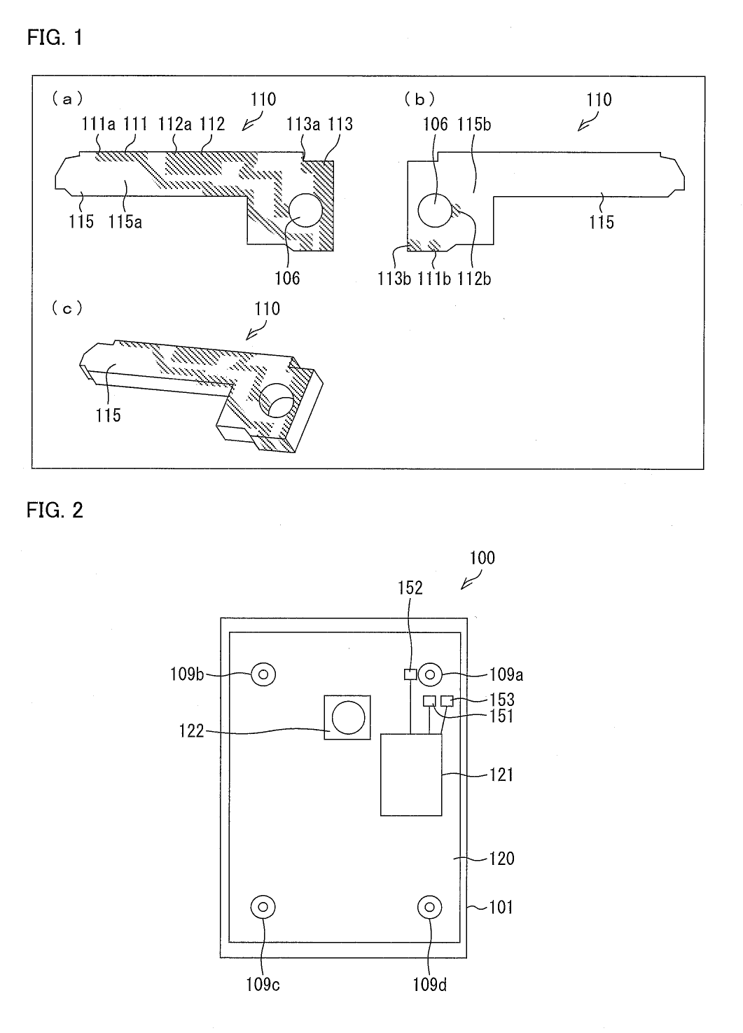

FIG. 1 is a diagram schematically illustrating a configuration of an antenna assembly 110 in accordance with an embodiment (Embodiment 1) of the present invention. (a) of FIG. 1 is a top view of the antenna assembly 110, (b) of FIG. 1 is a rear view of the antenna assembly 110, and (c) of FIG. 1 is an oblique perspective view of the antenna assembly 110. Note that the “antenna assembly” used in the present specification is referred to as a member including an antenna base; and an antenna element formed by, for example, metal plating applied to a surface of the antenna base.

As illustrated in FIG. 1, in the antenna assembly 110, a first antenna element 111, a second antenna element 112, and a third antenna element 113 are formed on an antenna base 115.

FIG. 2 is a top perspective view schematically illustrating a portable wireless terminal 100 of Embodiment 1 in a state in which the antenna assembly 110 is omitted. The portable wireless terminal 100 is provided with a housing 101. The housing 101 includes: a wireless section circuit 121 for a cellular communication system; connection terminals 151 to 153 which are connected to the wireless section circuit 121 via transmission lines; and a circuit board 120 provided with a conductive component such as a camera. The housing 101 further includes bosses (screw receiving members) 109a to 109d which receive screws for fixing the housing 101.

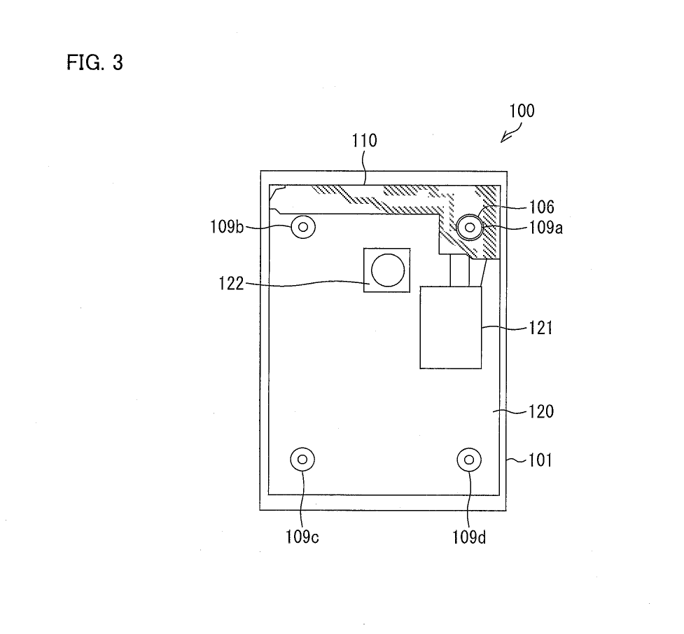

The antenna assembly 110 is to be arranged on the upper end of the circuit board 120 which corresponds to an upper part of FIG. 2 (on a side where the bosses 109a and 109b are provided). FIG. 3 is a top perspective view schematically illustrating the portable wireless terminal 100 in which the antenna assembly 110 is provided on the circuit board 120. Note that the antenna assembly 110 can be arranged in any place in outer part of the housing 101 (not particularly illustrated in FIG. 3), and therefore is not necessarily be arranged in the upper end of the housing 101 as described above. For example, the antenna assembly 110 can be arranged in a lower end of the housing 101. Even in such a case, a boss can be provided in a place on which the antenna assembly 110 is disposed.

Note that the “wireless section circuit” used in the present specification is a generic term which means at least any one of circuits including components, such as (i) a transmitter circuit, (ii) a receiver circuit, (iii) a switch for switching one antenna to another, (iv) a branching filter for separating (a) a flow from the transmitter circuit to an antenna from (b) a flow from the antenna to the receiver circuit, and (v) an IC.

The antenna base 115 (i) is made from a material, such as a dielectric material, a magnetic material, or ceramic, and (ii) has a certain thickness. An example of the antenna base 115 encompasses one having a length in its longitudinal direction of 45 mm, a length in its short side direction of 15 mm, and a thickness of 4.5 mm. These values can be appropriately modified in accordance with a shape of a portable wireless terminal to be employed. The antenna base 115 has a connection surface 115b which abuts on the circuit board 120, and a top surface 115a which is different from the connection surface 115b. Note that the top surface 115a is typically a surface on an opposite side of the connection surface 115b.

The first, the second, and the third antenna elements are formed by means of, for example, plating the top surface 115a of the antenna base 115 with an electric conductor, such as metal. By forming the first, the second, and the third antenna elements 111 to 113 on the antenna base 115, it is possible to (i) keep the first, the second, and the third antenna elements 111 to 113 away from the circuit board 120, and (ii) arrange them further outer part of the housing 101.

The first, the second, and the third antenna elements 111 to 113 extend partially to the connection surface 115b of the antenna base 115, and thus have, on the connection surface 115b, first, second and third connecting ends 111b to 113b, respectively, which are ends to be connected to the wireless section circuit 121. The first, the second, and the third connecting ends 111b to 113b will be connected to transmission lines on the circuit board 120 facing the connecting ends, via the connection terminals 151 to 153, such as springs provided on the circuit board 120, respectively. Each of the first, the second, and the third connecting ends 111b to 113b will be further connected to the wireless section circuit 121.

The first, the second, and the third antenna elements 111 to 113 further have, on the top surface 115a of the antenna base 115, first, second, and third apical ends 111a to 113a, respectively, which are opposite ends of the first, the second, and the third connecting ends 111b to 113b. The first, the second, and the third apical ends 111a to 113a are not connected to other conductive components, and thus open ends.

The antenna base 115 is provided with a boss hole (through hole) 106 through which the boss 109a passes. The second antenna element 112, large part of which (i) includes its second apical end 112a and (ii) exists on the top surface 115a, extends to the connection surface 115b through the boss hole 106 so as to form the second connecting end 112b on the connection surface 115b.

As described above, the first, the second, and the third apical ends 111a to 113a are formed on the top surface 115a of the antenna base 115, and the first, the second, and the third connecting ends 111b to 113b are formed on the connection surface 115b. According to a conventional configuration, an antenna element extends from the top surface 115a to the connection surface 115b along a side surface of the antenna base 115. However, in a case where a plurality of antenna elements extend to the connection surface 115b along a side surface of the antenna base 115, it is required to arrange connecting ends at positions which are distanced from each other in order to prevent deterioration in antenna characteristics which deterioration may be caused in a case where the antenna elements cross each other and get close to each other. Otherwise, the antenna elements are arranged unavoidably close to each other. According to the conventional configuration, therefore, (i) a feed line is made longer, resulting in a greater loss, in a case where the connecting ends are arranged at positions distanced from each other or (ii) mutual interference between the antenna elements is increased, resulting in deterioration in an antenna performance, in a case where the antenna elements are arranged close to each other. Such problems are particularly noticeable in a case where three or more antenna elements are formed on the antenna base 115.

In contrast, according to the configuration of Embodiment 1, at least any one of the first, the second, and the third antenna elements 111 to 113 extends from the top surface 115a to the connection surface 115b through the boss hole 106. This makes it possible to route all of the antenna elements so that their connecting ends are arranged at positions distanced from each other. This allows mutual interference between the antenna elements to be alleviated. The reason why the connecting ends are arranged close to each other is to reduce the lengths of the feed lines or the area in which matching circuits on respective feed lines are mounted by arranging the power feed sections of the antennas in a concentrated manner on one place in a case where three antenna elements, for example, are used in one system.

As described above, since the first, the second, and the third connecting ends 111b to 113b can be arranged close to each other, it is possible, by arranging the wireless section circuit 121 close to the connecting ends, to reduce each of the lengths of the feed lines from the wireless section circuit 121 to the connection parts. This allows reduction in loss in the feed lines. It is further possible, by arranging the connections in a concentrated manner on one place, to prevent the mounting area on the circuit board 120 from being reduced.

Note here that a hole through which at least any one of the first, the second, and the third antenna elements 111 to 113 passes is not limited to the boss hole 106, and can therefore be a through hole extending from the top surface 115a to the connection surface 115b. However, the hole is preferably a boss hole 106. This is because, generally in a mobile phone, bosses (see 109a to 109d of FIG. 2) for receiving screws are arranged near the four corners of the housing 101. Further, the antenna will be provided in one end of the housing. It is often necessary, due to the existence of such a boss in the end, to make a hole in part of an antenna base. As such, there is often a case where the antenna base 115 is originally provided with the boss hole 106. In such a case, the boss hole 106 is also used as a hole through which an antenna element passes without the need for providing the antenna base 115 with a new through hole. This can prevent the provision of the new through hole from reducing a degree of freedom in routing the first, the second, and the third antenna elements 111 to 113.

A screw made from metal will be inserted into the boss 109a which passes through the boss hole 106. Note, however, that, thanks to the thickness of the boss 109a, the screw is sufficiently distanced from the wall surface of the boss hole 106. This avoids significant deterioration in antenna characteristics.

Note further that the shape of the through hole and the boss hole are not limited to a specific one, and can therefore be circular or polygon.

The following description will discuss the first, the second, and the third antenna elements 111 to 113 in further detail.

In Embodiment 1, the first antenna element 111 operates in a first frequency band, the second antenna element 112 operates in a second frequency band, and the third antenna element 113 operates in a third frequency band. The first, the second, and the third frequency bands are higher in frequency in this order. Embodiment 1 describes an example in which: 800 to 900 MHz band for WCDMA, AMPS, EGSM, CDMA2000 or the like is used as the first frequency; 1.5 GHz band for WCDMA Band XI, GPS or the like is used as the second frequency band; and 1.7 to 2.1 GHz band for WCDMA, DCS, PCS, CDMA2000, or the like is used as the third frequency band. Note, however, that the present invention is not limited to the example.

Generally, the length of an antenna element is inversely proportional to the frequency in which such an antenna element operates. That is, an antenna element which operates in lower frequency band is longer. Therefore, the first antenna element 111, the second antenna element 112, and the third antenna element 113 are shorter in this order. As illustrated in (a) of FIG. 1, the first connecting end 111b and the third connecting end 113b are formed at positions which are closer to the second connecting end 112b rather than to the second apical end 112a, and the third connecting end 113b is formed closer to a corner of the antenna base 115 than the first connecting end 111b is. And, the second antenna element 112 is formed so as to be sandwiched by the first antenna element 111 and the third antenna element 113.

Note that the wording used in the present specification “the second antenna element 112 is formed so as to be sandwiched by the first antenna element 111 and the third antenna element 113” means that large part, i.e., at least more than half, of the second antenna element 112 is formed in a space between the first antenna element 111 and the third antenna element 113 on a surface of the antenna base 115. In another respect, the wording used in the present specification “the second antenna element 112 is formed so as to be sandwiched by the first antenna element 111 and the third antenna element 113” includes a situation where the first antenna element 111, the second antenna element 112, and the third antenna element 113 are arranged in an arbitrary direction in this order, and preferably where the first antenna element 111, the second antenna element 112, and the third antenna element 113 are arranged in this order from a side near the conductive component.

Also note that the wording “closer to a corner of the antenna base 115” means a position distanced farther from the center of the antenna base 115.

According to Embodiment 1, (i) the first connecting end 111b and the third connecting end 113b are formed at positions which are closer to the second connecting end 112b rather than to the second apical end 112a, (ii) the third connecting end 113b is formed closer to a corner of the antenna base 115 than the first connecting end 111b is, and (iii) the second antenna element 112 is formed so as to be sandwiched by the first antenna element 111 and the third antenna element 113. Therefore, the first apical end 111a, the second apical end 112a, and the third apical end 113a are arranged in this order. Further, according to Embodiment 1, each of the first, the second, and the third connecting ends 111b to 113b is formed at a position which is closer to the third apical end 113a rather than to the first apical end 111a. This makes it possible to set distances from an area where the first, the second, and the third connecting ends 111b to 113b are provided to each of the first, the second, and the third apical ends 111a to 113a in such a manner that the distance from the area to the first apical end 111a is longest, and the distance from the area to the third apical end 113a is shortest.

As such, by forming the first, the second, and the third antenna elements 111 to 113 as described above, it is possible to successfully arrange the first, the second, and the third connecting ends 111b to 113b close to each other.

This allows an improvement in antenna characteristics. The following description will discuss, in another respect, the arrangement of the first, the second, and the third antenna elements 111 to 113. As illustrated in (a) of FIG. 1, (i) each of the first, the second, and the third apical ends 111a to 113a is formed on an end of the antenna assembly 110 which end is closer to an outer edge of the housing 101, (ii) the second antenna element 112 is formed so as to be sandwiched by the first antenna element 111 and the third antenna element 113 on the antenna base 115, and (iii) each of the first, the second, and the third connecting ends 111b to 113b is formed at a position which is closer to the third apical end 113a rather than to the first apical end 111a.

That is, since the first, the second, and the third apical ends 111a to 113a are formed on an end of the antenna assembly 110 which end is closer to an outer edge of the housing 101 (see FIG. 3), an improvement in characteristics of the first, the second, and the third antenna elements 111 to 113 is achieved without sacrificing characteristics of any of the antenna elements. In other words, an increase in size of the first, the second, and the third antenna elements 111 to 113 in order to maintain their characteristics is hardly required. It is thus possible to meet recent requirements in downsizing and slimming down of a portable wireless terminal.

Further in another respect, the first, the second, and the third apical ends 111a to 113a are not covered with other antenna elements, when seen from an opposite side of a side in which the conductive components, such as the wireless section circuit 121 and a camera 122, are provided. This prevents a characteristic of any one of the first, the second, and the third antenna elements 111 to 113 from being sacrificed.

Further, since (i) the second antenna element 112 is formed so as to be sandwiched by the first antenna element 111 and the third antenna element 113 on the antenna base 115, and (ii) each of the first, the second, and the third connecting ends 111b to 113b is formed on a position which is closer to the third apical end 113a rather than to the first apical end 111a, it is possible to arrange the first, the second, and the third connecting ends 111b to 113b so that they are not separated from each other.

The following description will discuss the reason why such arrangement of the first, the second, and the third antenna elements 111 to 113 are preferable.

As early described, the first antenna element 111 has the longest length, a second antenna element 112 has a length which is shorter than that of the first antenna element 111, and the third antenna element 113 has the shortest length. In order to arrange the first, the second, and the third connecting ends 111b to 113b close to each other, it is necessary to set distances from the area where the first, the second, and the third connecting ends 111b to 113b are provided to each of the first, the second, and the third apical ends 111a to 113a in such a manner that the distance from the area to the first apical end 111a is longest, and the distance from the area to the third apical end 113a is shortest. Note, here, that it is difficult to meet such a condition unless the first, the second, and the third antenna elements 111 to 113 are formed as described above.

That is, according to Embodiment 1, the second antenna element 112 is formed so as to be sandwiched by the first antenna element 111 and the third antenna element 113. Therefore, the first apical end 111a, the second apical end 112a, and the third apical end 113a are arranged in this order. Further, according to Embodiment 1, each of the first, the second, and the third connecting ends 111b to 113b is formed at a position which is closer to the third apical end 113a rather than to the first apical end 111a. This makes it possible to set distances from the area in which the first, the second, and the third connecting ends 111b to 113b are provided to each of the first, the second, and the third apical ends 111a to 113a in such a manner that the distance from the area to the first apical end 111a is longest, and the distance from the area to the third apical end 113a is shortest.

As such, by forming the first, the second, and the third antenna elements 111 to 113 as described above, it is possible to successfully arrange the first, the second, and the third connecting ends 111b to 113b close to each other. This allows an improvement in antenna characteristics.

In an antenna assembly as described above which includes three antenna elements in which the second antenna element 112 is routed so as not to pass through the inside of the boss hole 106, it is required that large part of the second antenna element 112 is routed on the connection surface of the antenna base 110 in order not to cross the first antenna element 111 and the third antenna element 113. In this case, since the connection surface of the antenna base 110 is located near the circuit board 120, the second antenna element 112 can get close to electric conductors, such as metal components mounted on the circuit board 120, speakers arranged on the housing, and an FPC, that is, components which have per se resonance. Such components can adversely affect the second antenna element 112 so as to cause deterioration in antenna characteristics in the second frequency. In contrast, according to Embodiment 1, the second antenna element 112 extends from the second connecting end 112b to the second apical end 112a via the inside of the boss hole 106. It is thus possible to prevent the second antenna element 112 from getting close to such components. This can prevent deterioration in antenna characteristics. Further, since a degree of freedom in the arrangement of antenna elements is increased, it is possible to arrange the antenna elements so as to prevent them from (i) interfering with each other or (ii) adversely affecting each other.

Embodiment 1 has described a case where three antenna elements are arranged. Note, however, that the number of the antenna elements is not limited to three. The present invention is suitably applicable to a case where a plurality of the antenna elements are provided.

According to a conventional antenna assembly, it is necessary to separate the antenna elements from each other in order to improve antenna performance. This necessitates making the antenna larger. In contrast, according to the antenna assembly of the present invention, it is possible to separate the antenna elements from each other easily within a limited space. This effectively allows downsizing of an antenna.

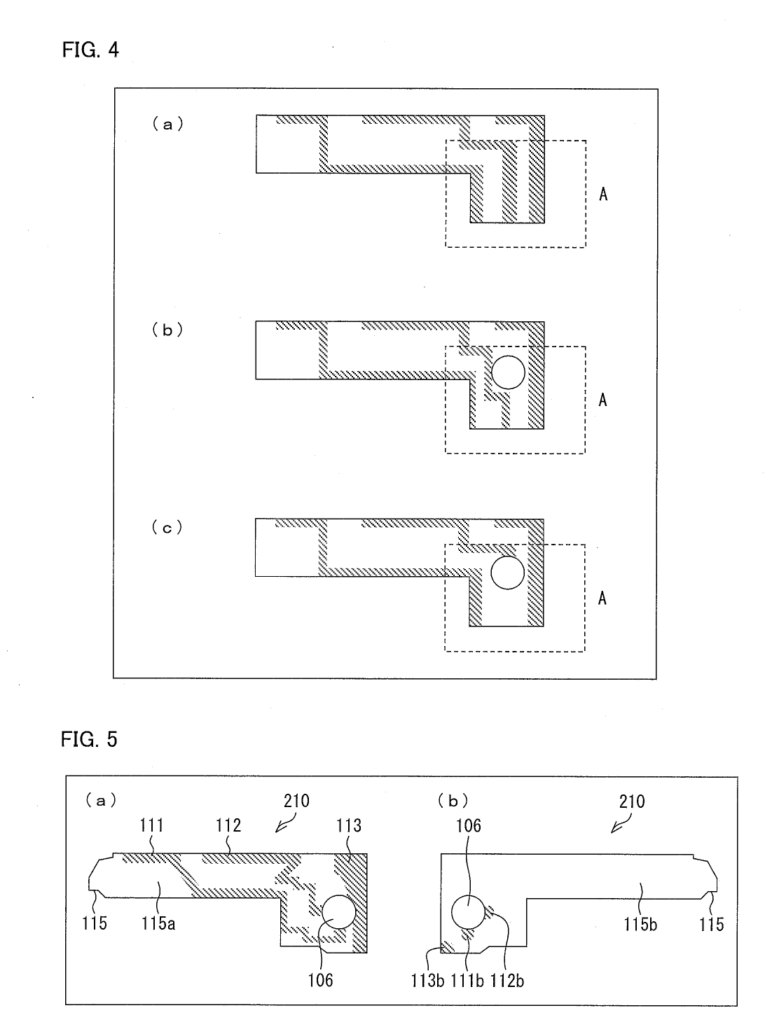

FIG. 4 illustrates various configurations of an antenna element. (a) of FIG. 4 illustrates a case where no boss hole is provided, (b) of FIG. 4 illustrates a case where a boss hole is provided through which an antenna element does not pass, and (c) of FIG. 4 illustrates a case where a boss hole is provided through which an element passes. (a) and (b) of FIG. 4 illustrate examples of the conventional configuration, and (c) of FIG. 4 illustrates an example of the present invention.

In a case where an element passes through a boss hole (see (c) of FIG. 4), there are only a few places in which the antenna elements get close to each other. In contrast, in a case where an element does not pass through a boss hole (see (b) of FIG. 4), the antenna elements get significantly close to each other particularly in an area A indicated in FIG. 4. In such a case, even in a case where each of the antenna elements is formed thinly, there can be problems, such as deterioration in antenna performance, mutual interference between the antenna elements, and difficulty in antenna formation. In a case where no boss hole is provided (see (a) of FIG. 4), there are fewer places in which the antenna elements get close to each other, as compared with the case illustrated in (b) of FIG. 4. However, such places are larger than those in the case illustrated in (c) of FIG. 4. In the case illustrated in (a) of FIG. 4, it is required to arrange the boss hole in a place other than the antenna section. This necessitates more space in the housing of a wireless terminal, and leads to a large sized wireless terminal. As described above, the case where an antenna element passes through the boss hole (see (c) of FIG. 4) is most effective case for enabling the distance between the antenna elements to be ensured.

Embodiment 1 has discussed an example of an antenna assembly provided on a straight terminal. Note, however, that Embodiment 1 is applicable without difficulty to a portable wireless device of (i) a type, such as clam shell type, in which housings are openable and closeable, or of (ii) a slide type. Also note that the number of the antenna elements which pass through the boss hole 106 is not limited to one (1). The following description will discuss a case where a plurality of antenna elements pass through the boss hole 106 with reference to Embodiments 2 and 3.

### Embodiment 2

The following description will discuss another embodiment (Embodiment 2) of the present invention with reference to FIG. 5. The same reference numerals are given to the members which are equivalent to those in Embodiment 1, and their descriptions are omitted. FIG. 5 is a diagram schematically illustrating a configuration of an antenna assembly 210 in accordance with Embodiment 2. (a) of FIG. 5 is a top view and (b) of FIG. 5 is a rear view of the antenna assembly. As illustrated in FIG. 5, the antenna assembly 210 is configured such that not only a second antenna element 112 but also a first antenna element 111 pass through a boss hole 106. That is, each of the first antenna element 111 and the second antenna element 112 extends from a top surface 115a to a connection surface 115b along part of a wall surface of the boss hole 106.

### Embodiment 3

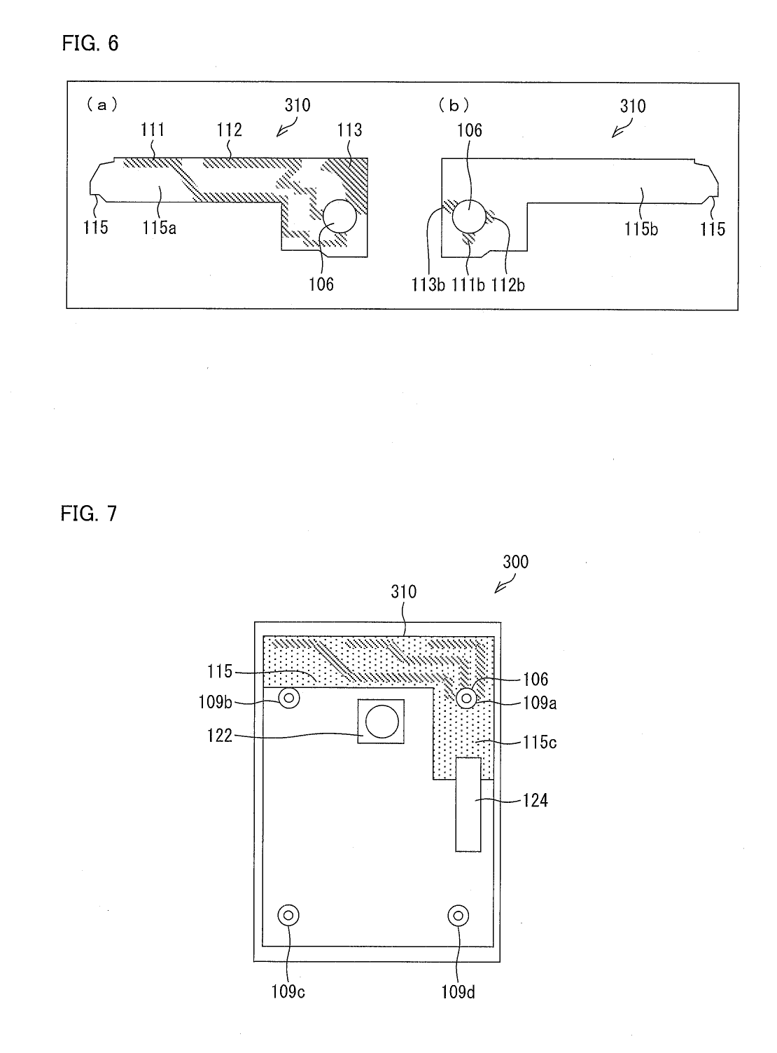

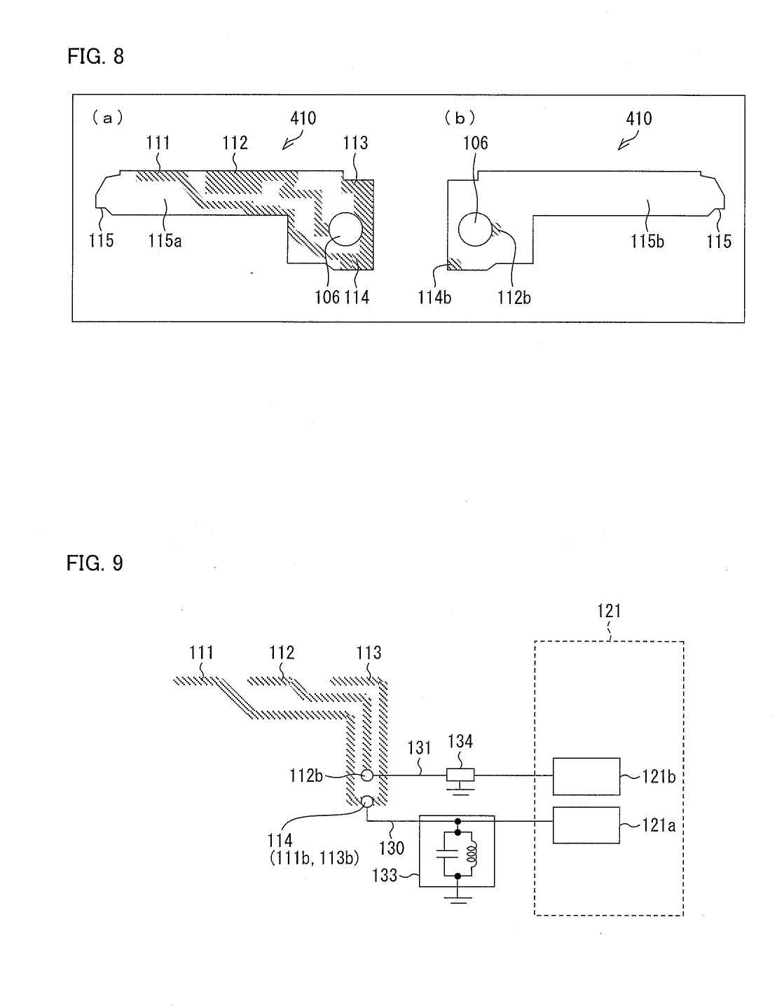

The following description will discuss yet another embodiment (Embodiment 3) of the present invention with reference to FIGS. 6 and 8. The same reference numerals are given to the members which are equivalent to those in Embodiment 1, and their descriptions are omitted. FIG. 6 is a diagram schematically illustrating a configuration of an antenna assembly 310 in accordance with Embodiment 3. (a) of FIG. 6 is a top view and (b) of FIG. 6 is a rear view of the antenna assembly. As illustrated in FIG. 6, the antenna assembly 310 is configured such that all antenna elements 111 to 113 pass through a boss hole 106. That is, each of the first antenna element 111, the second antenna element 112, and the third antenna element 113 extends from a top surface 115a to a connection surface 115b along part of a wall surface of the boss hole 106, and none of the antenna elements extends from a top surface 115a to a connection surface 115b along a side surface of an antenna base 115.

It is thus possible to freely select a shape of the side surface of the antenna base 115. For example, as illustrated in FIG. 7, the antenna base 115 can be extended so that part of the antenna base 115 is used as a supporting section (supporting means) 115c for supporting a vibrator 124. Note that the supporting section 115c can support any component suitably selected in accordance with the configuration of a portable wireless terminal 300 of Embodiment 3. That is, the supporting section 115c can support a speaker or other member, instead of the vibrator 124.

As such, according to Embodiment 3, the antenna base 115 has a degree of freedom in shape. This allows the antenna base 115 to also serve as a supporting means for supporting another member. It is thus possible to reduce the number of components of the portable wireless terminal 300. This brings about an advantage in cost.

### Embodiment 4

The following description will discuss yet another embodiment (Embodiment 4) of the present invention with reference to FIGS. 8 through 13. The same reference numerals are given to the members which are equivalent to those in Embodiment 1, and their descriptions are omitted. FIG. 8 is a diagram schematically illustrating a configuration of an antenna assembly 410 of Embodiment 4. (a) of FIG. 8 is a top view and (b) of FIG. 8 is a rear view of the antenna assembly. As illustrated in FIG. 8, the antenna assembly 410 is configured such that a first connecting end 111b is physically connected to a third antenna element 113 at a position near a third connecting end 113b, and a second antenna element 112 extends from a top surface 115a to a connection surface 115b through a boss hole 106. For explanation of advantages of Embodiment 4, the following description will first discuss a configuration in which the first connecting end 111b is physically connected to the third antenna element 113.

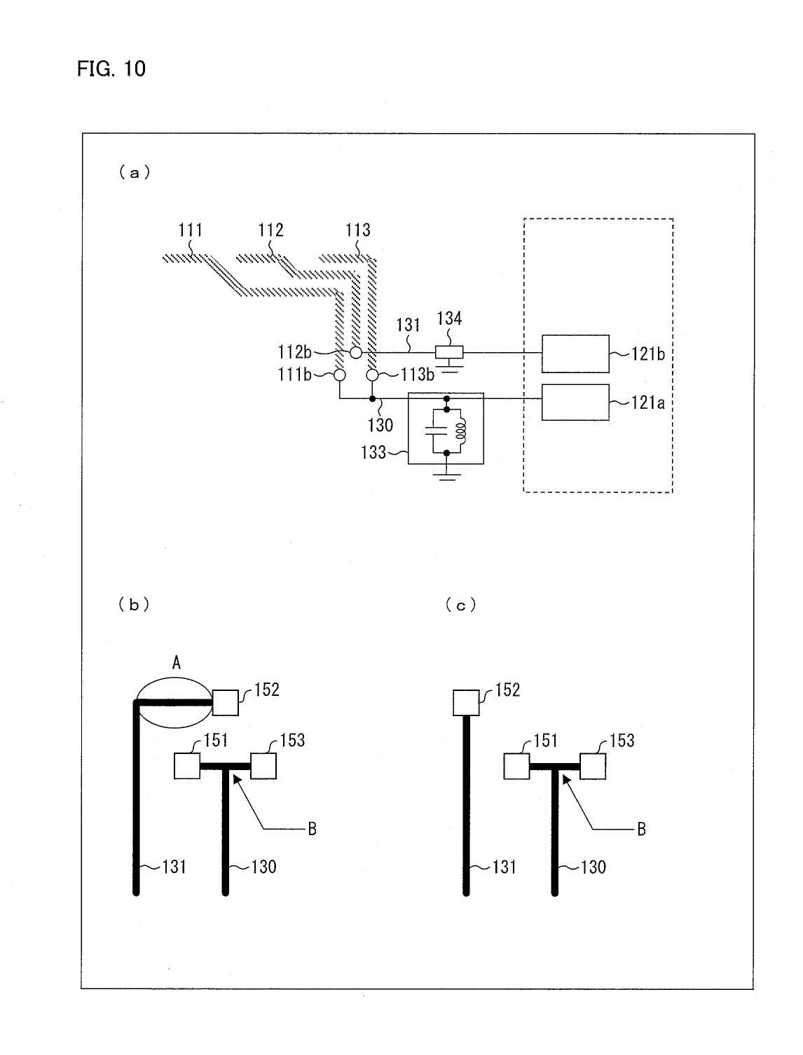

FIG. 9 illustrates a configuration in which the first connecting end 111b is physically connected to a third connecting end 113b. As illustrated in FIG. 9, the first connecting end 111b is physically connected to the third antenna element 113 at a position near the third connecting end 113b on the antenna base 115 so as to form a connecting end 114. The connecting end 114 is shared by the first antenna element 111 and the third antenna element 113. A first wire 130 connects the connecting end 114 to a first circuit load 121a of a wireless section circuit 121. A second wire 131 connects a second connecting end 112b to a second circuit load 121b of the wireless section circuit 121.

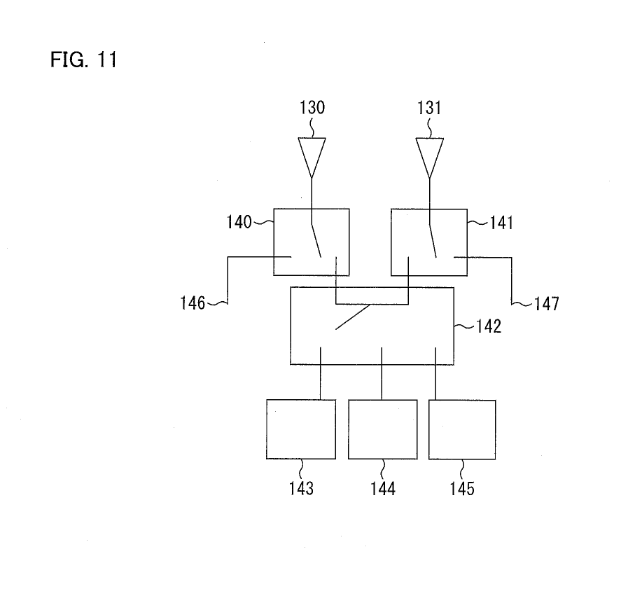

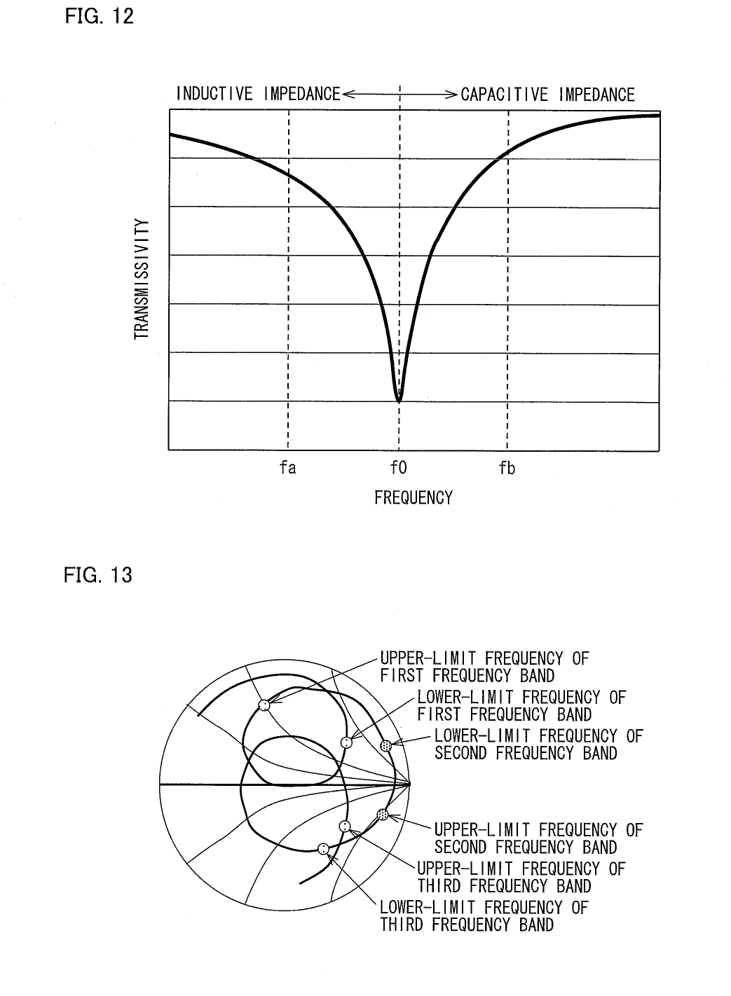

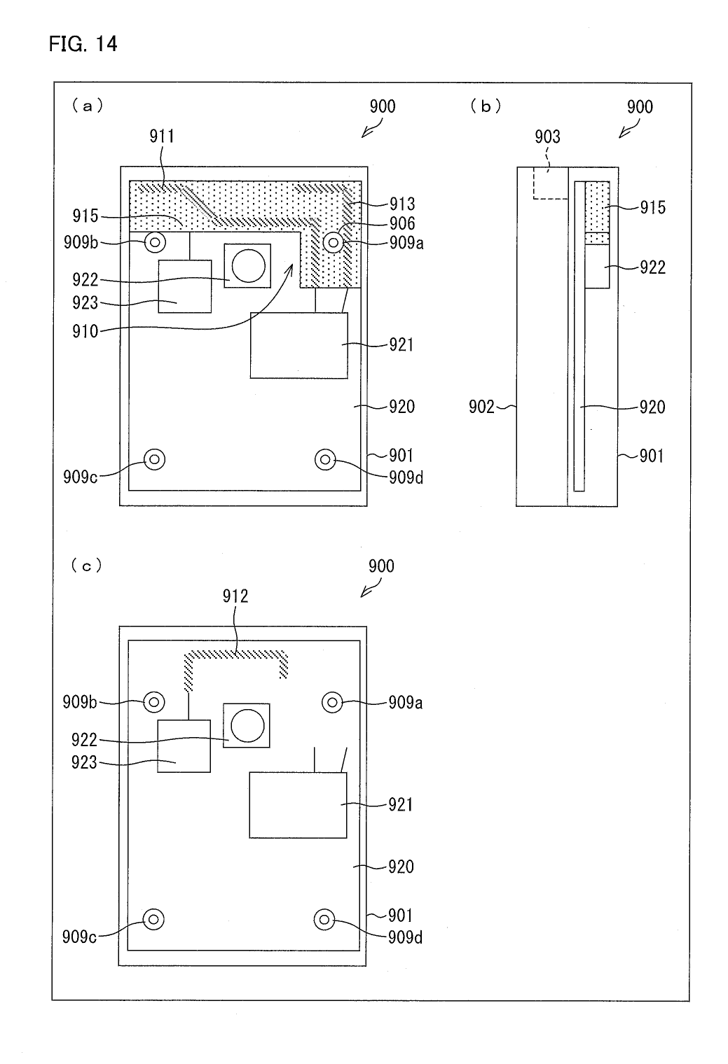

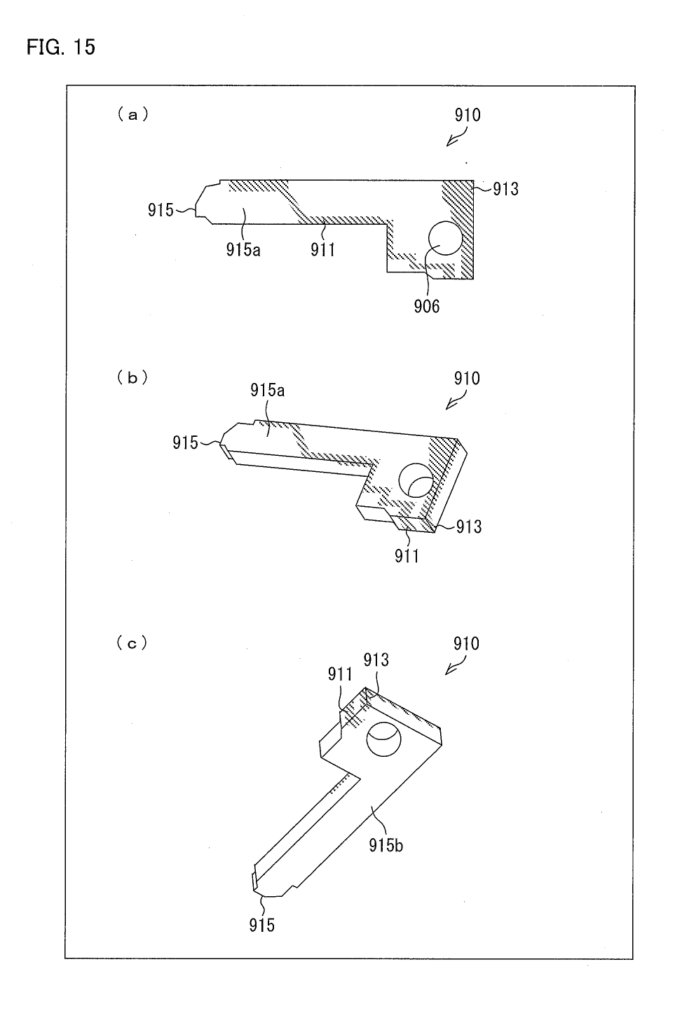

FIG. 11 is a diagram illustrating an example of a configuration of the wireless section circuit 121. With the use of a switch 140, a signal from the first wire 130 which is connected to the first antenna element 111 and the third antenna element (see FIG. 9) will be supplied to (i) a switch 142 in a case where the first antenna element 111 or the third antenna element is used or to (ii) a first not-in-use terminal 146 for use in a case where none of the first antenna element 111 and the third antenna element is used. With the use of a switch 141, a signal from the second wire 131 which is connected to the second antenna element 112 (see FIG. 9) will be supplied to (i) the switch 142 in a case where the second antenna element 112 is used or to (ii) a not-in-use second terminal 147 for use in a case where the second antenna element 112 is not used. Note that the first not-in-use terminal 146 and the second not-in-use terminal 147 can have impedance (see FIG. 12) which is unique to such a switching element. Alternatively, a designer can select any suitable impedance from constants for adjustment which are loaded in advance in the first and the second terminal. The switch 142 will cause the signal to be supplied (i) to a first RF circuit 143 for processing a signal in a first frequency band; (ii) to a second RF circuit 144 for processing a signal in a second frequency band; or (iii) to a third RF circuit 145 for processing the signal in a third frequency band, in accordance with an antenna element to be used. According to such a configuration, the wireless section circuit 121 includes the first circuit load 121a and the second circuit load 121b.

As described above, by partially integrating feed lines through which power is fed from the wireless section circuit 121 to the first, the second, and the third antenna elements 111 to 113 into one feed line, it is possible to save space and cost. This is because the large number of feed lines requires the corresponding large number of connection terminals for respectively connecting the connecting ends, through which the antenna elements are connected to the matching circuit, to the wires on the circuit board 120. This causes an increase in the number of components, and thus a reduction in area on the circuit board 120 in which the conductive components can be mounted.

Note, here, that integrating the feed line to the first antenna element 111 and the feed line to the third antenna element 113 into one feed line is the most suitable combination. This is because, a difference between the first frequency band in which the first antenna element 111 operates, and the third frequency band in which the third antenna element 113 operates is larger than a difference between the first frequency band or the third frequency band, and the second frequency band in which the second antenna element 112 operates. According to Embodiment 4, the second frequency band is of a frequency about two times as high as that of the first frequency band, so that the second antenna element 112 and the first antenna element 111 are subjected to an anti-resonance vibration. Further, the second frequency band has a frequency which is approximate to the lower frequency (about 1.7 GHz) in the third frequency improvement in antenna characteristics can thus be achieved. In contrast, the third frequency band is of a frequency of about three times as high as that of the first frequency band, and the third and the first frequency bands are not approximate to each other, so that only small mutual interference occurs. This allows improvement in antenna characteristics. It is thus possible to integrate a feed line to the first antenna element 111 and a feed line to the third antenna element 113 into one feed line appropriately. Further, according to Embodiment 4, since the second antenna element 112 passes through the boss hole 106, it is possible to arrange, near the respective connecting ends, the antenna element 111 or the antenna element 113 distanced from the antenna element 112. This allows a further reduction in (i) influences of the antenna element 111 and the antenna element 113 on the antenna element 112, and (ii) an influence of the antenna element 112 on the antenna element 111 and the antenna element 113.

Further, it is possible, by integrating the feed line to the first antenna element 111 and the feed line to the third antenna element 113 into one feed line, to minimize the influences of the first antenna element 111 and the third antenna element 113 on the second antenna element 112, as will be described below.

As illustrated in FIG. 9, in a case where a first matching section 133 for matching the first antenna element 111 and the third antenna element 113 is provided between the first antenna element 111/the third antenna element 113 and the first circuit load 121a, and a second matching section 134 for matching the second antenna element 112 is provided between the second antenna element 112 and the second circuit load 121b, the first matching section 133 is preferably a parallel resonant circuit which is (i) provided parallel to the first wire 130 and (ii) connected to a ground. As illustrated in FIG. 12, the parallel resonant circuit has transmission characteristics such that it serves as (i) an inductive circuit in a frequency which is lower than a resonance frequency f0 or (ii) a capacitive circuit in a frequency which is higher than the resonance frequency f0. Note here that, in a case where the resonance frequency f0 is adjusted so as to be included in the third frequency band, the first matching section 133 serves as a substantially inductive element (parallel L matching) with respect to the first frequency band. The first antenna element 111 which serves as a λ/4 monopole antenna can thus have a length which is slightly shorter than λ/4. This allows downsizing of the antenna 210. It is further possible to cause the third antenna element 113 to have a broader frequency by means of resonances of the third antenna element 113 and the parallel resonant circuit. This also allows downsizing of the antenna 210.

Let it be assumed here that, in FIG. 9, an input terminal to the first antenna element 111 and the third antenna element 113 is defined as a port 1, the first antenna element 111 including the first matching section 133, and an input terminal to the second antenna element 112 is defined as a port 2, the second antenna element 112 including the second matching section 134. The following description will discuss how operate an antenna input impedance from the port 1 towards the first antenna element 111 and the third antenna element 113. In a frequency which is lower than f0, the parallel resonant circuit serves as an inductive element, in which the impedance is rotated counterclockwise on a Smith chart. And, the amount of the counterclockwise rotation of the impedance is reduced as the frequency approaches f0, and the impedance is not rotated at the frequency of f0. On the other hand, in a frequency which is higher than f0, the parallel resonant circuit serves as a capacitive element, in which the impedance is rotated clockwise on the Smith chart. And, the amount of the clockwise rotation of the impedance is increased as the frequency becomes higher. Therefore, the frequency characteristics of the antenna input impedance of the port 1 will typically be one as illustrated in the Smith chart of FIG. 13.

As illustrated in FIG. 13, in the second frequency band, impedance seen from the port 1 approaches substantially open. Here, an amount of a mutual coupling between the antennas can be indicated by transmission amplitude from the port 1 to the port 2 (hereinafter indicated as |S21|, equivalent to the transmission amplitude |S12| from the port 2 to the port 1). In a case where impedance in the second frequency band when seen from the port 1 is open, |S21| becomes smaller. That is, the mutual coupling between the antennas will be reduced. This makes it possible to minimize the influence of the first antenna element 111 and the third antenna element 113 on the second antenna element.

According to the antenna of Embodiment 4, at least any one of the first antenna element 111, the third antenna element 113, and the first wire 130 can include a frequency control section (frequency control means) for increasing input impedance in the second frequency band from a input side of the first antenna element 111 and the third antenna element 113. The length of each antenna element and the constant of antenna matching are affected by the conductive members (metal components, ground, etc.) in the vicinity of the antenna assembly 210, changes in conductor shape due to a transformable housing that can take any one of a plurality of shapes such as open/close, or the like. Therefore, the length is not always ideal. Further, these effects may have a frequency characteristic, so that the impedance is not rotated uniformly on the Smith chart as illustrated in FIG. 7. This makes readjustment necessary. Note that, as a frequency control section, a circuit element such as an inductor or a condenser, a stub pattern having inductive or capacitive impedance, or the like can be used.

As described above, there are some advantages in physically connecting the first connecting end 111b to the third connecting end 113b.

As is clear from FIG. 8, in an antenna assembly in which antenna elements are arranged as described above, it is difficult to route the second antenna element 112 to the connection surface 115b in a case where the first connecting end 111b is connected physically to the third connecting end 113b on the top surface 115a of the antenna base 115. According to Embodiment 4, however, by causing the second antenna element 112 to pass through the boss hole 106, it is easily possible to extend the second antenna element 112 to the connection surface 115b, even in a case where the first connecting end 111b is connected physically to the third connecting end 113b.

Note that, in Embodiment 4, in addition to the second antenna element 112, an antenna element into which the first antenna element 111 and the third antenna element 113 are integrated can pass through the boss hole 106.

### Embodiment 5

The following description will discuss yet another embodiment (Embodiment 5) of the present invention with reference to FIGS. 1 through 10. The same reference numerals are given to the members which are equivalent to those in Embodiment 1 or 4, and their descriptions are omitted. As illustrated in (a) of FIG. 10, Embodiment 4 has a configuration similar to that of Embodiment 4 (FIG. 9), except that (i) an antenna assembly has a configuration as illustrated in FIG. 1, and (ii) a first wire 130 is branched into two wires on the way, in which one of the two wires is connected to the first connecting end 111b and the other of the two wires is connected to the third connecting end 113b.

As illustrated in FIG. 1 and (a) of FIG. 10, antenna elements of Embodiment 5 respective of which have (i) a first apical end 111a, a second apical end 112a, and a third apical end 113a which are arranged in this order, and (ii) a second connecting end 112b, a first connecting end 111b, and a third connecting end 113b arranged in this order. In a case where the respective connecting ends of the antenna elements are arranged in the order same as that of arrangement of the apical ends, namely, the order of the first connecting end 112b, the second connecting end 111b, and the third connecting end 113b, it is necessary to route the second wire 131 on the circuit board 120 so as to detour the first wire 130 (see A in (b) of FIG. 10). This causes the length of the wire to be extended, resulting in increase in loss. In contrast, according to Embodiment 5, it is not necessary to route the second wire 131 so as to detour the first wire 130 (see (c) of FIG. 10). This allows the length of the wire to be shortened. It is thus possible to reduce so much loss as caused otherwise by the extension of the wire. Note that, in (b) and (c) of FIG. 10, a branch point of the first wire 130 is denoted as B.

In Embodiments 1 to 5, antenna elements are formed by patterning surfaces of antenna bases. Note, however, that the present invention is not limited to those embodiments. The present invention encompasses a configuration in which antenna elements are formed by means of a sheet metal or other material.

The present invention has been described specifically with reference to embodiments, however, the present invention is not limited to the above-mentioned embodiments, and can therefore be modified in many ways within the scope of Claims. The technical scope of the present invention encompasses embodiments obtained by combining the technical means appropriately modified within the scope of Claims.

### SUMMARY

In order to solve the above-mentioned problems, an antenna assembly in accordance with the present invention is an antenna assembly including: an antenna base; and a plurality of antenna elements formed on a surface of the antenna base, the antenna base having: a connection surface on which connecting ends of the plurality of antenna elements are provided, the connecting ends being ends which are connected to a wireless section circuit; and a through hole formed through the antenna base from the connection surface to another surface; and at least one of the antenna elements being configured to pass through the through hole. According to the configuration, at least one of the antenna elements passes through the through hole so as to be routed to the connection surface. Therefore, an improvement in a degree of freedom when routing the antenna elements can be achieved, as compared with a case where all of the antenna elements are routed to the connection surface along the side surface. For example, since the antenna elements can be distanced from each other, it is possible to alleviate mutual interference between the antennas. It is further possible to avoid deterioration in antenna characteristics, the deterioration being caused in a case where, in order for one antenna element to prevent from crossing the other antenna element, the one antenna element gets closer to other metal body mounted on the circuit board or arranged in the housing. Furthermore, since the through hole can be provided in an arbitrary place, a degree of freedom in an arrangement of antenna elements is significantly improved. This allows an ideal arrangement of the antenna elements. Moreover, since the antenna element can pass through anywhere inside of the through hole, a connection part of the antenna element on the circuit board can also be arranged in an arbitrary place near the through hole.

The antenna assembly in accordance with the present invention can be configured such that three or more of the antenna elements are provided on the surface of the antenna base.

According to the antenna assembly of the present invention, at least one of the antenna elements is routed to the connection surface through the through hole. Therefore, even in a case where three or more of the antenna elements are provided, it is possible to distance the antenna elements from each other so as to alleviate mutual interference between antennas appropriately.

The antenna assembly is preferably configured such that, of the three or more of the antenna elements, any one antenna element sandwiched by two other antenna elements is configured to pass through the through hole.

According to the configuration, any one antenna element sandwiched by two other antenna elements, namely, any one antenna element other than both outer antenna elements is configured to pass through the through hole. The both outer antenna elements can easily be configured such that they pass along a side surface of the antenna base, whereas any one antenna element other than the both outer antenna elements can have a low degree of freedom in routing, so that it can be difficult to distance antenna elements from each other. According to the configuration, by configure the any one antenna element other than the both outer antenna elements so as to pass through the through hole, it is possible to improve a degree of freedom in routing. This allows the antenna elements to successfully be distanced from each other.

The antenna assembly can be configured such that the three or more of the antenna elements include: a first antenna element which operates in a first frequency band; a second antenna element which operates in a second frequency band which is higher than the first frequency band; and a third antenna element which operates in a third frequency band which is higher than the second frequency band, and respective of the first, the second, and the third antenna elements have first, second, and third connecting ends and first, second, and third apical ends which are opposite ends of the first, the second, and the third connecting ends.

The antenna assembly is preferably configured such that (i) an angle formed by a side from the first connecting end to the second connecting end and a side from the first connecting end to the third connecting end or (ii) an angle formed by a side from the third connecting end to the first connecting end and a side from the third connecting end to the second connecting end are obtuse angles.

In a case where the angle formed by a side from the first connecting end to the second connecting end and a side from the first connecting end to the third connecting end is an obtuse angle, the connecting ends will be arranged in the order of the second connecting end, the first connecting end, and the third connecting end. Further, the angle formed by a side from the third connecting end to the first connecting end and a side from the third connecting end to the second connecting end will be arranged in the order of the first connecting end, the third connecting end, and the second connecting end.

Since the first antenna element and the third antenna element operate in frequency bands which are apart from each other, it is also possible to integrate the wires to be connected to the corresponding connecting ends into one wire on the circuit board. However, in a case, for example, where the connecting ends are arranged in the order of the first connecting end, the second connecting end, and the third connecting end, such integration of the wires to be connected to the first and the third connecting ends into one wire inevitably causes the wire to be connected to the second connecting end to detour the integrated wire. This brings about an extension of the feed line, resulting in a great loss. In contrast, according to the present configuration in which the connecting ends are arranged as described above, it is not necessary to provide the wire to be connected to the second connecting end so as to detour the integrated wire, even in a case where the wires to be connected to the first and the third connecting ends are integrated into one wire. This can successfully prevent an extension of the feed line and an increase in loss.

The antenna assembly is preferably configured such that the second antenna element is formed so as to be sandwiched by the first antenna element and the third antenna element, the first connecting end and the third connecting end are formed at positions which are closer to the second connecting end rather than to the second apical end, the third connecting end is formed closer to a corner of the antenna base than the first connecting end is, and the second antenna element is formed so as to pass through the through hole.

According to the configuration, the antenna assembly includes the first, the second, and the third antenna elements. And, respective of the first, the second, and the third antenna elements have (i) first, second, and third connecting ends and (ii) first, second, and third apical ends. The first connecting end and the third connecting end are formed at positions which are closer to the second connecting end rather than to the second apical end, the third connecting end is formed closer to a corner of the antenna base than the first connecting end is, and the second antenna element is formed so as to be sandwiched by the first antenna element and the third antenna element. This allows an antenna assembly having excellent antenna characteristics to be provided. Since the second antenna element is sandwiched by the first antenna element and the third antenna element, it is difficult to route the second antenna element to the connection surface along a side surface of the antenna base. According to the configuration, the second antenna element is successfully routed to the connection surface through the through hole. A successful routing of the second antenna element can thus be achieved.

The following description will discuss in detail why the configuration can provide an antenna assembly having excellent antenna characteristics. In general, in order to improve characteristics of antenna elements to be arranged, apical ends of the antenna elements are arranged in an outer side of a wireless device on which the antenna elements are mounted. That is, it is preferable to arrange the antenna elements so as to be distanced from a metal body provided on the wireless device. According to the configuration, the antenna elements are arranged in the order of the shortest antenna element to the longest antenna element from the position which is near the outer side of the antenna base. It is thus possible to form the apical ends of the antenna elements in any one of ends of the antenna base. That is, it is possible to form the apical ends of the antenna elements in an outer side of the wireless device. According to the configuration, it is possible to easily attain an antenna which has good antenna characteristics elements.

Further, in order to arrange all of the antenna elements such that their connecting ends are not distanced from each other, it is necessary to arrange (i) the first connecting end and the third connecting end at positions which are closer to the second connecting end rather than to the second apical end, and (ii) the third connecting end closer to a corner of the antenna base than the first connecting end is.

According to the configuration, the second antenna element is arranged so as to be sandwiched by the first antenna element and the third antenna element. Therefore, the first apical end, the second apical end, and the third apical end are arranged in this order. According to the configuration, it is thus possible to attain the antenna in which connections at which each of the antenna elements are connected to the wireless section circuit are not distanced from each other.

As such, according to the configuration, it is possible to attain an antenna in which (A) all of the antenna elements have good characteristics, and (B) connections at which each of the antenna elements are connected to the wireless section circuit are not distanced from each other. Therefore, even in a case where the antenna elements are used for a same system, it is possible to attain an antenna assembly which can obtain good characteristics. Note that an antenna in accordance with the present invention would be appropriately applicable to a case where all of the antenna elements are used for utilization of a plurality of systems. The antenna assembly can be configured such that the first connecting end is connected physically to a position of the third antenna element which position is closer to the third connecting end rather than to the third apical end.

According to the configuration, first connecting end is connected physically to a position of the third antenna element which position is closer to the third connecting end rather than to the third apical end. It is thus possible to integrate a feed system from the wireless section circuit to the first antenna element and a feed system from the wireless section circuit to the third antenna element into one feed system. An increase in the number of feed systems will cause an increase in the numbers of (i) the antenna matching circuit, (ii) springs for connecting circuit boards to the antenna elements, and (iii) other components. This also cause an increase in area in which such antenna components are mounted, and a reduction in area on the circuit board in which other conductive components are to be amounted. However, according to the configuration, it is possible to suppress the reduction in area on the circuit board in which conductive components other than the antenna components are to be amounted. Further, since the first antenna element and the third antenna element have frequency bands which are mostly apart from each other, it is possible to suppress mutual interference which can be caused in a case where the feed systems are integrated into one feed system.

Note here that the second antenna element is sandwiched by the first and the third antenna elements, which are physically connected to each other. It is significantly difficult to route the second antenna element to the connection surface along a side surface of the antenna base. According to the present configuration, the second antenna element is routed to the connection surface through the through hole. This allows a successful routing of the second antenna element.

As described above, particularly in a case where (i) an angle formed by a side from the first connecting end to the second connecting end and a side from the first connecting end to the third connecting end or (ii) an angle formed by a side from the third connecting end to the first connecting end and a side from the third connecting end to the second connecting end are obtuse angles, it is possible to appropriately route the wire to be connected to the second connecting end on the circuit board. This allows a further improvement in antenna performance.

The antenna assembly in accordance with the present invention is preferably configured such that the through hole is a hole through which a screw receiving member passes.

According to the configuration, the through hole is also used as a hole through which a screw receiving member passes. This can prevent the formation of an additional hole in the antenna base. Further, since the antenna element can pass through anywhere inside of the hole, it is possible to further improve a degree of freedom in routing the antenna element and in arrangement of ends on the circuit board. As the result, it is possible to attain good antenna characteristics.

The antenna assembly in accordance with the present invention can be configured such that all of the plurality of antenna elements are formed so as to pass through the through hole, and the antenna base includes, in its part in which the plurality of antenna elements are not formed, supporting means for supporting another object.

According to the configuration, all of the antenna elements are routed to the connection surface through the through hole, and none of them are routed along the side surface. Therefore, an improvement in a degree of freedom in shape of the side surface of the antenna base can be achieved. Further, the antenna base can serve also as a supporting means for supporting another member. It is thus possible to reduce the entire number of the components of the device including such an antenna assembly.

The antenna assembly in accordance with the present invention can be configured such that the plurality of antenna elements are used in a same system.

As described above, the antenna assembly in accordance with the present invention has an improved degree of freedom in arrangement of the antenna elements. This allows the above-described three connecting ends to be provided close to each other. The present invention can be appropriately applicable to a case where the three or more antenna elements are used in a same system.

A portable wireless terminal in accordance with the present invention includes an antenna assembly in accordance with the present invention.

According to the configuration, a portable wireless terminal having improved antenna characteristics can be provided.

### INDUSTRIAL APPLICABILITY

The present invention is suitably applicable to an antenna for use in a general wireless communication, in particular, to an antenna for a portable wireless terminal and a field of manufacturing of a wireless device provided with such an antenna.

### REFERENCE SIGNS LIST

100 Portable wireless terminal
300 Portable wireless terminal
900 Portable wireless terminal
101 Housing
109a Boss (Screw receiving member)
109b Boss (Screw receiving member)
109c Boss (Screw receiving member)
109d Boss (Screw receiving member)
110 Antenna assembly
210 Antenna assembly
310 Antenna assembly
410 Antenna assembly
106 Boss hole (through hole)
111 First antenna element
112 Second antenna element
113 Third antenna element
111a First apical end
112a Second apical end
113a Third apical end
111b First connecting end
112b Second connecting end
113b Third connecting end
114 Connecting end
115 Antenna base
115a Top surface
115b Connection surface
115c Supporting section (Supporting means)
120 Circuit board
121 Wireless section circuit
121a First circuit load
121b Second circuit load
122 Camera
124 Vibrator (Other member)
130 First wire
131 Second wire
133 First matching section
134 Second matching section
146 First not-in-use terminal
147 Second not-in-use terminal
900 Portable wireless terminal
901 First housing
902 Second housing
903 Coupling member
911 First antenna element
912 Second antenna element
913 Third antenna element
915 Antenna base
920 Circuit board
921 Wireless section circuit for cellular communication
922 Camera
923 Wireless section circuit for GPS

1.-10. (canceled)

11. (canceled)

12. An antenna assembly comprising:
an antenna base; and
three or more antenna elements formed on a surface of the antenna base,
the three or more antenna elements being connected to a wireless section circuit,
the antenna base having: a connection surface on which connecting ends of the three or more antenna elements are provided, the connecting ends being ends which are connected to a wireless section circuit; and a through hole formed through the antenna base from the connection surface to another surface;
of the three or more antenna elements, any one antenna element which is sandwiched by two antenna elements being configured to pass through the through hole, and
the through hole being arranged between two antenna elements other than the antenna element which passes through the through hole.

13. An antenna assembly comprising:
an antenna base; and
three or more antenna elements formed on a surface of the antenna base,
the antenna base having: a connection surface on which connecting ends of the three or more antenna elements are provided, the connecting ends being ends which are connected to a wireless section circuit; and a through hole formed through the antenna base from the connection surface to another surface,
of the three or more antenna elements, any one antenna element which is sandwiched by two antenna elements being configured to pass through the through hole,
the three or more antenna elements including: a first antenna element which operates in a first frequency band; a second antenna element which operates in a second frequency band which is higher than the first frequency band; and a third antenna element which operates in a third frequency band which is higher than the second frequency band,
respective of the first, the second, and the third antenna elements having first, second, and third connecting ends and first, second, and third apical ends which are opposite ends of the first, the second, and the third connecting ends, and
(i) an angle formed by a side from the first connecting end to the second connecting end and a side from the first connecting end to the third connecting end or (ii) an angle formed by a side from the third connecting end to the first connecting end and a side from the third connecting end to the second connecting end being obtuse angles.

14. An antenna assembly comprising:
an antenna base; and
a plurality of antenna elements formed on a surface of the antenna base,
the antenna base having: a connection surface on which connecting ends of the plurality of antenna elements are provided, the connecting ends being ends which are connected to a wireless section circuit; and a through hole formed through the antenna base from the connection surface to another surface,
all of the plurality of antenna elements being formed so as to pass through the through hole, and
the antenna base including, in its part in which the plurality of antenna elements are not formed, supporting means for supporting another object.

15. An antenna assembly comprising:
an antenna base; and
three or more antenna elements formed on a surface of the antenna base,
the antenna base having: a connection surface on which connecting ends of the three or more antenna elements are provided, the connecting ends being ends which are connected to a wireless section circuit; and a through hole formed through the antenna base from the connection surface to another surface,
the three or more antenna elements including: a first antenna element which operates in a first frequency band; a second antenna element which operates in a second frequency band which is higher than the first frequency band; and a third antenna element which operates in a third frequency band which is higher than the second frequency band, and
respective of the first, the second, and the third antenna elements having first, second, and third connecting ends and first, second, and third apical ends which are opposite ends of the first, the second, and the third connecting ends,
the second antenna element being formed so as to be sandwiched by the first antenna element and the third antenna element,
the through hole being arranged between the first antenna element and the third antenna element,
the second antenna element being formed so as to pass through the through hole,
the first connecting end and the third connecting end being formed at positions which are closer to the second connecting end rather than to the second apical end,
the third connecting end being formed closer to a corner of the antenna base than the first connecting end is, and
the first connecting end being connected physically to a position of the third antenna element which position is closer to the third connecting end rather than to the third apical end.

16. The antenna assembly as set forth in claim 13 wherein:
the second antenna element is formed so as to be sandwiched by the first antenna element and the third antenna element,
the first connecting end and the third connecting end are formed at positions which are closer to the second connecting end rather than to the second apical end,
the third connecting end is formed closer to a corner of the antenna base than the first connecting end is, and
the second antenna element is formed so as to pass through the through hole.

17. The antenna assembly as set forth in claim 13 wherein:
the first connecting end is connected physically to a position of the third antenna element which position is closer to the third connecting end rather than to the third apical end.

18. The antenna assembly as set forth in claim 12 wherein:
the through hole is a hole through which a screw receiving member passes.

19. The antenna assembly as set forth in claim 12 wherein:
all of the plurality of antenna elements are formed so as to pass through the through hole, and the antenna base includes, in its part in which the plurality of antenna elements are not foamed, supporting means for supporting another object.

20. The antenna assembly as set forth in claim 12 wherein:
the plurality of antenna elements are used in a same system.

21. A portable wireless terminal comprising an antenna assembly recited in claim 12.
